(19) United States
(12) Patent Application Publication
(10) Pub. No.: US 2015/0238785 A1
(43) Pub. Date: Aug. 27, 2015

(54) Nasal Mask

(71) Applicants: SHU YUAN CHUANG, Toufen Township (TW); YUNG SHAN CHIU, Toufen Township (TW); SHIH WEN CHIU, Toufen Township (TW)

(72) Inventors: SHU YUAN CHUANG, Toufen Township (TW); YUNG SHAN CHIU, Toufen Township (TW); SHIH WEN CHIU, Toufen Township (TW)

(21) Appl. No.: 14/591,931

(22) Filed: Jan. 8, 2015

(30) Foreign Application Priority Data
Jan. 10, 2014 (TW) 103200498

(51) Int. Cl. A62B 23/06

(52) U.S. Cl. CPC A62B 23/06

(57) ABSTRACT

A nasal mask contains: a body including a flexible supporting portion, a holding portion, and an filter accommodating hole. The filter accommodating hole communicates with the body, the flexible supporting portion has a rear segment for abutting against an inner side of the user's nostril, and the holding portion is biased against an outer side of the user's nostril. A fastening cover rotatably is connected with the holding portion and includes a plurality of air orifices communicating with the filter accommodating hole. A three-dimensional filter is fixed in and is removed from the body, the three-dimensional filter includes a twisted filtration fence and an extending flange, and the twisted filtration fence has plural curved sections for filtering air in the three-dimensional filter, the extending flange extends outwardly from a bottom end of the three-dimensional filter and is retained between the holding portion and the fastening cover.

### FIELD OF THE INVENTION

The present invention relates to a nasal mask which obtains airtightness between user's nostril and the nasal mask, air filtration through a three-dimensional filter, smooth breath, and using comfort.

### BACKGROUND OF THE INVENTION

A conventional protective mask, such as n95, is employed to filter/stop bacteria and viruses, wherein the protective mask n95 has a metal bar arranged around a peripheral side thereof and has two elastic straps for wearing the protective mask n95 on user's ears, such that high airtightness is achieved among the protective mask, user's nose and face. However, the user feels uncomfortable as wearing the protective mask n95. Wearing common medical masks is more comfortable than wearing protective mask n95, but airtightness between the common medical masks and the user's nostril cannot satisfy using requirement, for example, unclean air (i.e., viruses, bacteria and dust mites) are breathed into the user's body from gaps between the user's nose bridge and face.

Moreover, a conventional invisible nasal mask contains a body fixed in user's nostril, but it causes discomfort and poor airtightness between the invisible nasal mask and the user's nostril.

The present invention has arisen to mitigate and/or obviate the afore-described disadvantages.

### SUMMARY OF THE INVENTION

The primary objective of the present invention is to provide a nasal mask which obtains airtightness between user's nostril and the nasal mask, air filtration through a three-dimensional filter, smooth breath, and using comfort.

To obtain the above objective, a nasal mask provided by the present invention contains: a body which includes a flexible supporting portion, a holding portion, and a filter accommodating hole. The filter accommodating hole communicates with the body, the flexible supporting portion has a rear segment for abutting against an inner side of the user's nostril, and the holding portion is biased against an outer side of the user's nostril to avoid a removal of the nasal mask. A rotatable cover is rotatably connected with a bottom end of the holding portion and includes a plurality of air orifices communicating with the filter accommodating hole. A three-dimensional filter is fixed in and is removed from the body, the three-dimensional filter includes a twisted filtration fence and an extending flange, and the twisted filtration fence has plural curved sections for filtering air in the three-dimensional filter, the extending flange extends outwardly from an outer side of a bottom end of the three-dimensional filter and is retained between the holding portion and the rotatable cover.

Preferably, the holding portion further includes at least one locking groove for engaging with and disengaging from the at least one hook, the rotatable cover further includes at least one hook for engaging with and disengaging from the locking groove.

Preferably, the holding portion further includes at least one connecting portion for connecting with the rotatable cover, and each connecting portion has a stop block for stopping the rotatable cover after the rotatable cover rotates an angle relative to the body.

Preferably, the holding portion includes a round rib arranged on an inner wall thereof and contacting with the extending flange of the three-dimensional filter.

Preferably, the rotatable cover further includes at least one boss for contacting with the extending flange.

Preferably, the flexible supporting portion has at least one cutout defined on a peripheral wall thereof.

Preferably, the nasal mask further contains at least one aromatic ball fixed in plural separated rooms of the three-dimensional filter defined by the plural curved sections of the twisted filtration fence, wherein a diameter of each aromatic ball is greater than that of each air orifice.

Thereby, a contacting area of the three-dimensional filter of the nasal mask is increased by using the body, the three-dimensional filter, and the rotatable cover; and a resistance of the three-dimensional filter is reduced, such that air flows into the user's nostril via the three-dimensional filter to avoid unfiltered air being breathed into the user's body, to breathe air smoothly, and to fix the nasal mask comfortably. In addition, the flexible supporting portion is formed in a sphere shape to obtain airtightness in the user's nostril.

### BRIEF DESCRIPTION OF THE DRAWINGS

FIG. 1 is a perspective view showing the assembly of a nasal mask according to a first embodiment of the present invention.

FIG. 2 is a perspective view showing the exploded components of the nasal mask according to the first embodiment of the present invention.

FIG. 3 is a cross sectional view showing the assembly of the nasal mask according to the first embodiment of the present invention.

FIG. 4 is another perspective view showing the assembly of the nasal mask according to the first embodiment of the present invention.

FIG. 5 is a cross sectional showing the application of the nasal mask according to the first embodiment of the present invention.

FIG. 6 is a cross sectional showing the assembly of a nasal mask according to a second embodiment of the present invention.

FIG. 7 is a cross sectional showing the application of the nasal mask according to the second embodiment of the present invention.

### DETAILED DESCRIPTION OF THE PREFERRED EMBODIMENTS

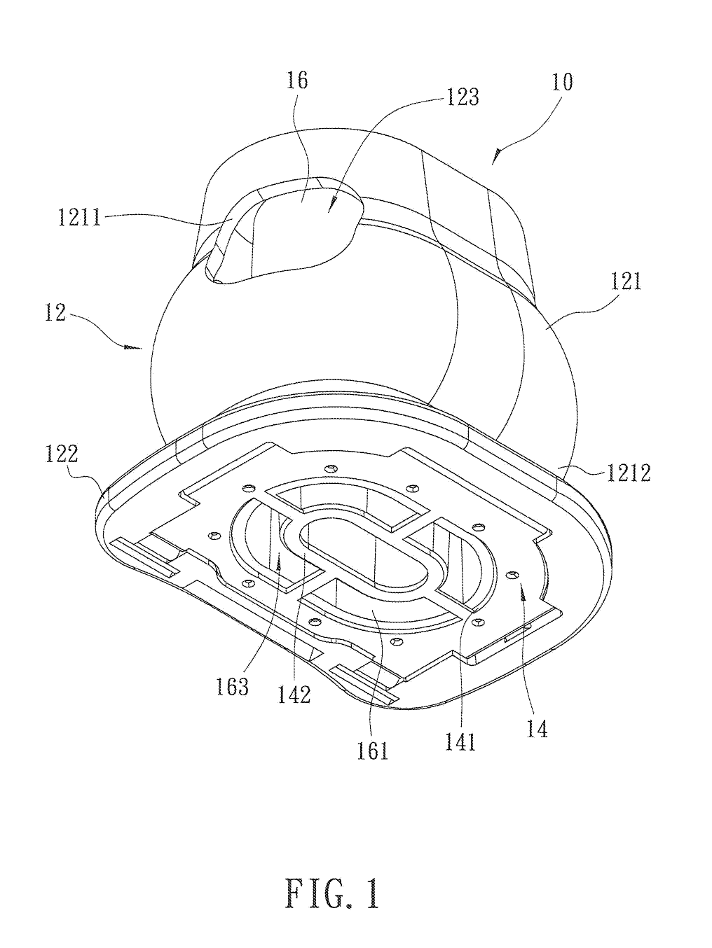

With reference to FIGS. 1 to 3, a nasal mask 10 according to a first embodiment of the present invention comprises: a body 12, a rotatable cover 14, and a three-dimensional filter 16. The nasal mask 10 is fixed in a user's nostril (not shown) to filter air flowing into the user's nostril.

The body 12 includes a flexible supporting portion 121 formed in a sphere shape to obtain airtightness in the user's nostril, a holding portion 122, and an filter accommodating hole 123, wherein the filter accommodating hole 123 communicates with the body 12, the flexible supporting portion 121 has a rear segment 1212 for abutting against an inner side of the user's nostril, and the holding portion 122 is biased against an outer side of the user's nostril. The body 12 is made of flexible material, such as silicone, to maintain airtightness between the body 12 and the user's nostril. A profile of the flexible supporting portion 121 has a central raised rim and two decreased ends to correspond to the user's nostril, thus avoiding a removal of the nasal mask 10 from the user's nostril and fixing the nasal mask 10 in the user's nostril conveniently.

The rotatable cover 14 is rotatably connected with a bottom end of the holding portion 122 and includes a plurality of air orifices 141 communicating with the filter accommodating hole 123, such that air flows into the body 12 from the plurality of air orifices 141.

The three-dimensional filter 16 is fixed in and is removed from the body 12. The three-dimensional filter 16 includes a twisted filtration fence 161 and an extending flange 162, and the twisted filtration fence 161 has plural curved sections for filtering air in the three-dimensional filter 16. The extending flange 162 extends outwardly from an outer side of a bottom end of the three-dimensional filter 16 and retained between the holding portion 122 and the rotatable cover 14.

The plural curved sections of the twisted filtration fence 161 are connected in any one of a W shape, a M shape, and a U shape to define plural separated rooms 163 in the three-dimensional filter 16, such that a contacting area of the three-dimensional filter 16 with the air in the three-dimensional filter 16 is increased, thus breathing the air smoothly.

The three-dimensional filter 16 is made of any one of single-layer meltblown nonwoven fabric, multilayer meltblown nonwoven fabric, and other fabrics, thus producing the three-dimensional filter 16 applicable for common protective level, PM2.5 degree or N95 nasal mask degree. The three-dimensional filter 16 is meltblown on a three-dimensional mold by a melt blown machine, is press formed by a male die and a female die, or is fabricated in an ultrasonic welding manner.

After using the nasal mask 10 for a period of time, the rotatable cover 14 is opened to remove the three-dimensional filter 16 from the body 12, thus discarding or washing the three-dimensional filter 16. Thereafter, a new/washed three-dimensional filter 16 is mounted in the body 12, and then the rotatable cover 14 is covered, thus replacing the three-dimensional filter 16.

Accordingly, the body 12 and the rotatable cover 14 are recyclable and have high filtration. Preferably, the three-dimensional filter 16 has common filtration and high filtration, hence the three-dimensional filter 16 is replaced based on using environment.

As fixing the nasal mask 10 in the user's nostril, the rear segment 1212 of the flexible supporting portion 121 abuts against the inner side of the user's nostril, and the holding portion 122 is biased against the outer side of the user's nostril so as to maintain the airtightness between the body 12 and the user's nostril. Preferably, the rotatable cover 14 is made of metal or reinforcement material to support the holding portion 122, thus abutting the holding portion 122 against the outer side of the user's nostril securely. In this embodiment, the rotatable cover 14 includes the plurality of air orifices 141 separated by plural ribs 142 to stop an object entering the body 12.

The three-dimensional filter 16 is produced at Nano standard or non-Nano standard to stop and filter bacteria and viruses effectively.

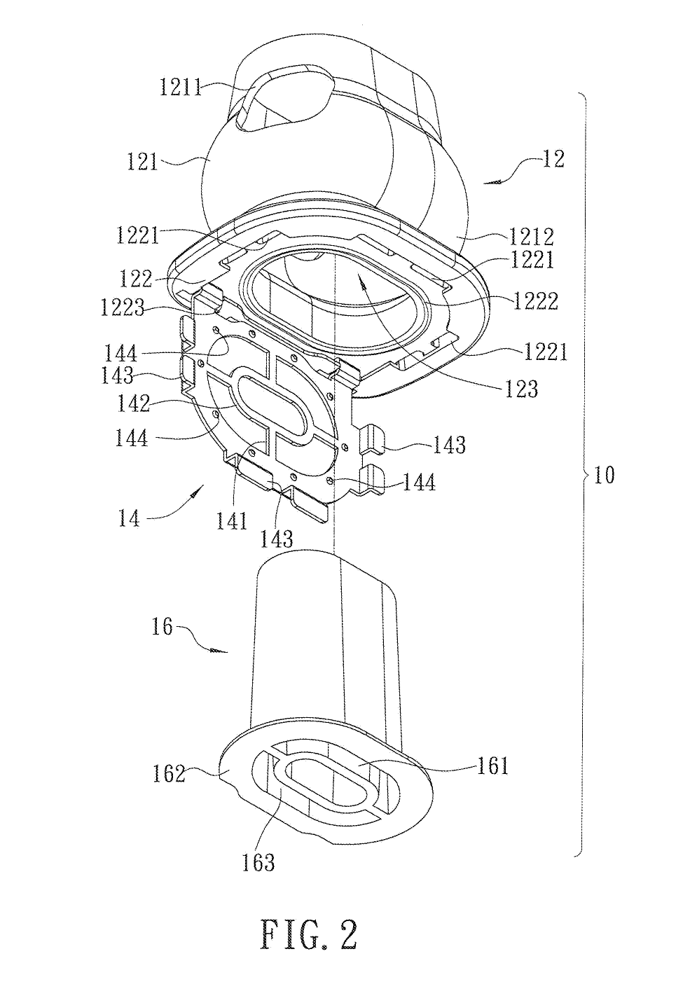

Referring to FIG. 2, the holding portion 122 further includes at least one locking groove 1221, and the rotatable cover 14 further includes at least one hook 143 for engaging with and disengaging from the at least one locking groove 1221, thus fixing the rotatable cover 14 on the holding portion 122 of the body 12. In this embodiment, there are six hooks 143 formed in an inverted L-shape and engaged with six locking grooves 1221. In addition, the six hooks 143 can be disengaged from the six locking grooves 1221, thus removing the rotatable cover 14 from the holding portion 122 of the body 12.

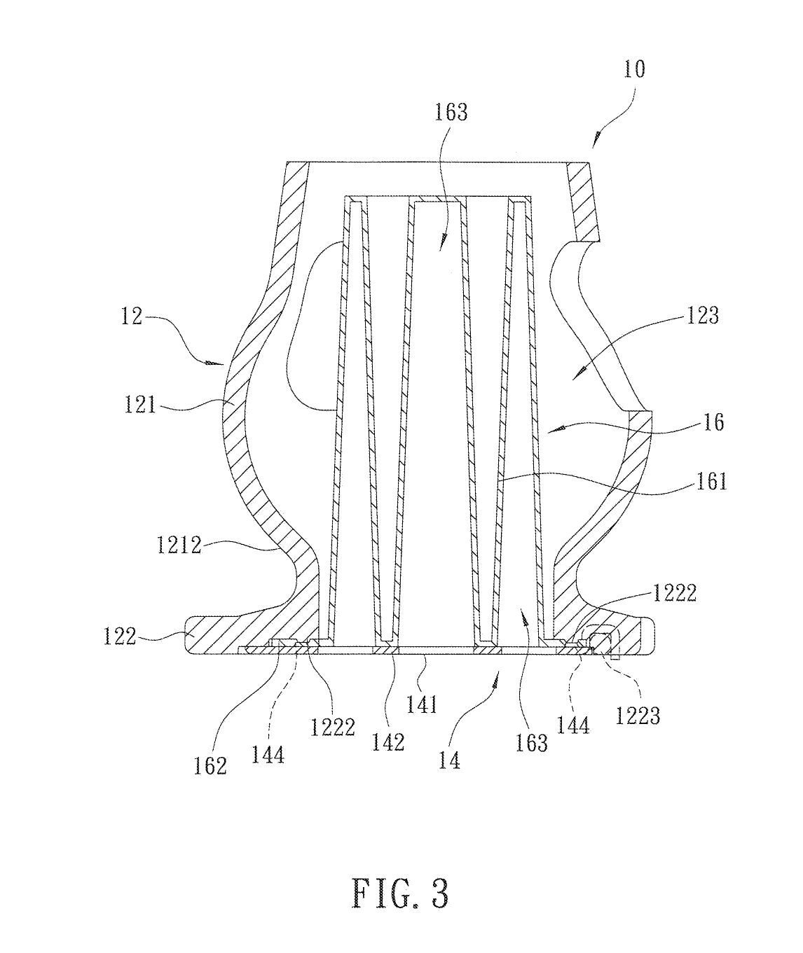

As shown in FIGS. 2 and 3, the holding portion 122 includes a round rib 1222 arranged on an inner wall thereof and contacting with the extending flange 162 of the three-dimensional filter 16, such that the extending flange 162 of the three-dimensional filter 16 contacts with the round rib 1222 tightly to avoid the air flowing into the body 12 via the rotatable cover 14, the extending flange 162, and the holding portion 122 without being filtered by the three-dimensional filter 16.

The rotatable cover 14 further includes at least one boss 144. In this embodiment, there are ten bosses 144 arranged on the rotatable cover 14 to contact with the extending flange 162 tightly, thus enhancing friction between the rotatable cover 14 and the three-dimensional filter 16. Preferably, the extending flange 162 is retained by the ten bosses 144 and the holding portion 122, thus preventing a movement of the three-dimensional filter 16 in the body 12.

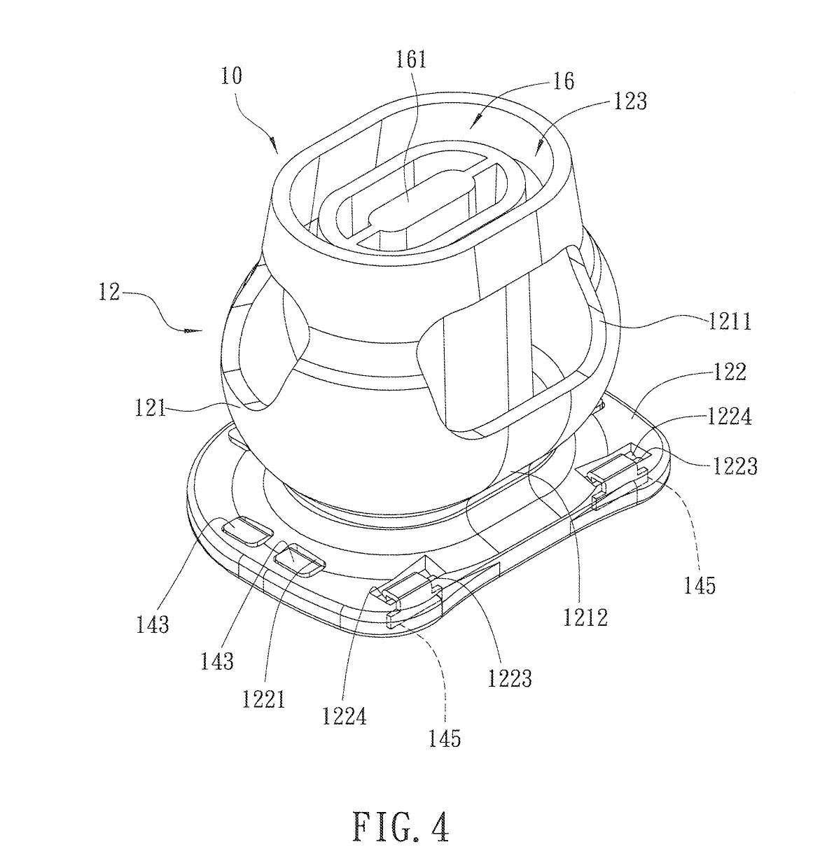

As illustrated in FIGS. 3 and 4, the holding portion 122 further includes at least one connecting portion 1223 for connecting with the rotatable cover 14, and each connecting portion 1223 has a stop block 1224 for stopping the rotatable cover 12 after the rotatable cover 14 rotates an angle relative to the body 12, such that the body 12 does not remove from the rotatable cover 14 and is not broken after the rotatable cover 14 is rotated overly. In this embodiment, each connecting portion 1223 is a connecting shaft, and the stop block 1224 is fixed on one end of the connecting shaft, the rotatable cover 14 further includes a column 145 mounted on a connection position of the rotatable cover 14 and each connecting shaft, such that after the rotatable cover 14 rotates an angle along each connecting shaft, it is stopped by the stop block 1224.

It is to be noted that a length of the body 12 is greater than that of the three-dimensional filter 16, such that the three-dimensional filter 16 does not contact the inner side of the user's nostril. The flexible supporting portion 121 has at least one cutout 1211 defined on a peripheral wall thereof to decrease the strength of the body 12, thus enhancing using comfort of the nasal mask.

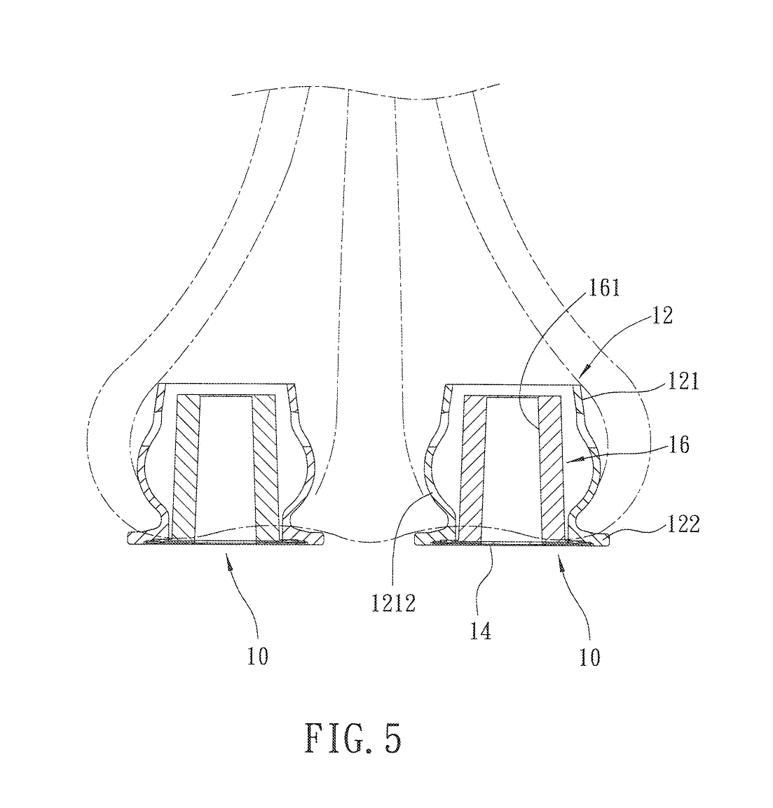

With reference to FIG. 5, in operation, the nasal mask 10 is fixed in the user's nostril, and a widest portion of the nasal mask 10 is parallel to a widest portion of the user's nostril, the rear segment 1212 of the flexible supporting portion 121 abuts against the inner side of the user's nostril, the holding portion 122 is biased against the outer side of the user's nostril, thus obtaining airtightness. In the meantime, the air flows into the body 12 from the plurality of air orifices 141 of the rotatable cover 14 via the three-dimensional filter 16. Since the contacting area of the three-dimensional filter 16 with the air is increased, the air flows through the three-dimensional filter 16 smoothly. Furthermore, the holding portion 122 is located outside the user's nostril, so the body 12 is not fixed in the user's nostril deeply, thus enhancing using comfort of the nasal mask 10.

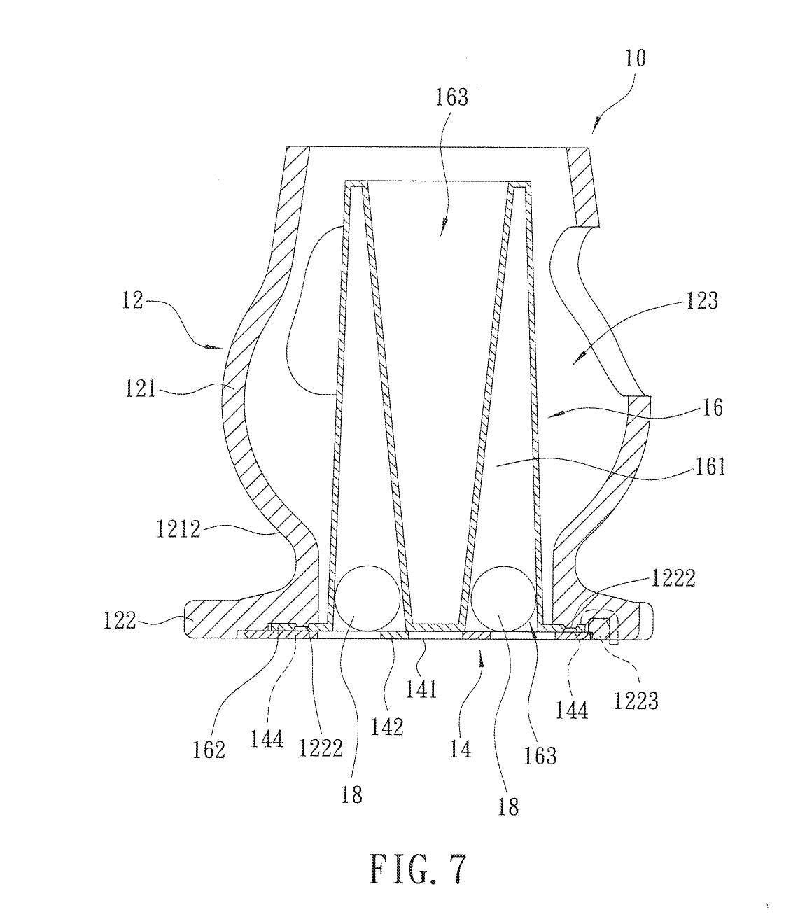

Referring to FIG. 7, the nasal mask 10 further comprises at least one aromatic ball 18 fixed in the plural separated rooms 163 of the three-dimensional filter 12, wherein a diameter of each aromatic ball 18 is greater than that of each air orifice 141, and the at least one aromatic ball 18 covers a waterproof layer (not shown) on the three-dimensional filter 16 to fix the at least one aromatic ball 18 in the three-dimensional filter 16 without removal, thus generating aroma.

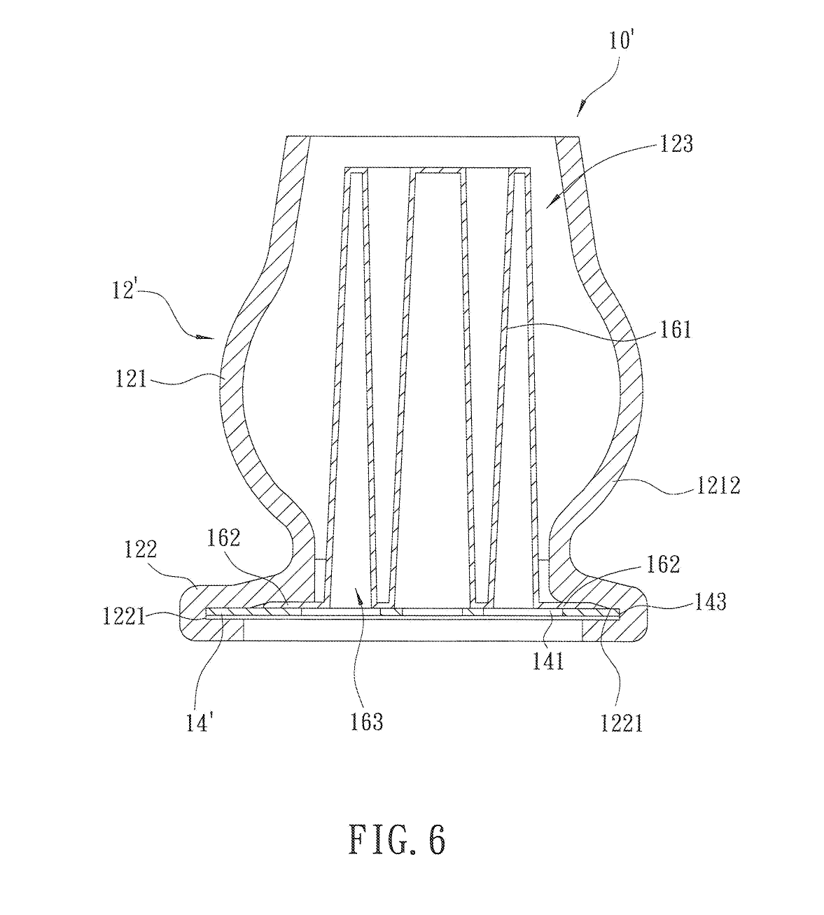

As shown in FIG. 6, a nasal mask 10′ according to a second embodiment of the present invention comprises: a body 12′, a fastening cover 14′, and a three-dimensional filter 16′.

A difference of the nasal mask 10′ of the second embodiment from that of the first embodiment comprises: a holding portion 122 of the body 12′ having at least one locking groove 1221 formed in a loop shape, the fastening cover 14′ including at least hook 143 being a peripheral side thereof, wherein the at least one locking groove 1221 retains with the peripheral side of the fastening cover 14′ and the extending flange 162 of the three-dimensional filter 16.

In operation, the holding portion 122 is manually expanded to accommodate the three-dimensional filter 16 in the body 12′, and the extending flange 162 of the three-dimensional filter 16 retains with the at least one locking groove 1221, the fastening cover 14′ is fastened and then is fixed in the holding portion 122, and the holding portion 122 is released so that the peripheral side of the fastening cover 14′ retains with the at least one locking groove 1221, i.e., the extending flange 162 of the three-dimensional filter 16 and the peripheral side of the fastening cover 14′ are retained by the at least one locking groove 1221, thus fixing the fastening cover 14′ and the three-dimensional filter 16 in the body 12′ securely. Preferably, the body 12′ is made of flexible material, and the holding portion 122 abuts against the extending flange 162 and the fastening cover 14′, thus obtaining airtightness.

After using the nasal mask 10′ for a period of time, the fastening cover 14′ is opened so that the three-dimensional filter 16 is removed from the body 12′ to be discarded or washed, and then a new/washed three-dimensional filter 16′ is placed in the body 12′, thereafter the fastening cover 14′ is covered on the body 12′, thus replacing the three-dimensional filter 16′.

Thereby, the contacting area of the three-dimensional filter is increased by using the body, the three-dimensional filter, and the fastening cover to reduce air resistance of the three-dimensional filter, thus obtaining airtightness between the user's nostril and the nasal mask, air filtration through the three-dimensional filter, smooth breath, and using comfort.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A nasal mask being fixed in user's nostril and comprising: a body which includes a flexible supporting portion, a holding portion, and an filter accommodating hole, wherein the filter accommodating hole communicates with the body, the flexible supporting portion has a rear segment for abutting against an inner side of the user's nostril, and the holding portion is biased against an outer side of the user's nostril; a fastening cover rotatably connected with a bottom end of the holding portion and including a plurality of air orifices communicating with the filter accommodating hole; a three-dimensional filter fixed in and removed from the body, the three-dimensional filter including a twisted filtration fence and an extending flange, and the twisted filtration fence having plural curved sections for filtering air in the three-dimensional filter, the extending flange extending outwardly from an outer side of a bottom end of the three-dimensional filter and being retained between the holding portion and the fastening cover.

2. The nasal mask as claimed in claim 1, wherein the holding portion further includes at least one locking groove for engaging with and disengaging from the at least one hook, the fastening cover further includes at least one hook for engaging with and disengaging from the locking groove.

3. The nasal mask as claimed in claim 1, wherein the holding portion further includes at least one connecting portion for connecting with the fastening cover, and each connecting portion has a stop block for stopping the fastening cover after the fastening cover rotates an angle relative to the body.

4. The nasal mask as claimed in claim 2, wherein the holding portion further includes at least one connecting portion for connecting with the fastening cover, and each connecting portion has a stop block for stopping the fastening cover after the fastening cover rotates an angle relative to the body.

5. The nasal mask as claimed in claim 1 wherein the holding portion includes a round rib arranged on an inner wall thereof and contacting with the extending flange of the three-dimensional filter.

6. The nasal mask as claimed in claim 1 wherein the fastening cover further includes at least one boss for contacting with the extending flange.

7. The nasal mask as claimed in claim 5, wherein the fastening cover further includes at least one boss for contacting with the extending flange.

8. The nasal mask as claimed in claim 1 wherein the flexible supporting portion has at least one cutout defined on a peripheral wall thereof.

9. The nasal mask as claimed in claim 5, wherein the flexible supporting portion has at least one cutout defined on a peripheral wall thereof.

10. The nasal mask as claimed in claim 6, wherein the flexible supporting portion has at least one cutout defined on a peripheral wall thereof.

11. The nasal mask as claimed in claim 1 further comprising at least one aromatic ball fixed in plural separated rooms of the three-dimensional filter defined by the plural curved sections of the twisted filtration fence.

12. The nasal mask as claimed in claim 5 further comprising at least one aromatic ball fixed in plural separated rooms of the three-dimensional filter defined by the plural curved sections of the twisted filtration fence.

13. The nasal mask as claimed in claim 6 further comprising at least one aromatic ball fixed in plural separated rooms of the three-dimensional filter defined by the plural curved sections of the twisted filtration fence.
